(19) United States
(12) Patent Application Publication
(10) Pub. No.: US 2005/0011688 A1
(43) Pub. Date: Jan. 20, 2005

(54) Pneumatic and fluid engines

(76) Inventor: Rudolph V. Bailey SR., Dover, DE (US)

Correspondence Address: RUDOLPH V. BAILEY SR., 140 ANTLERS LANE, BEAR, DE, 19701, US

(21) Appl. No.: 10/886,459

(22) Filed: Jul. 7, 2004

Related U.S. Application Data
(63) Continuation-in-part of application No. 10/811,382, filed on Mar. 27, 2004.
(60) Provisional application No. 60/485,414, filed on Jul. 8, 2003.

(51) Int. Cl. B60K 1/00

(52) U.S. Cl. 180/65.1

(57) ABSTRACT

A pneumatic and fluid engine that can replace gasoline and diesel fuel as an energy source for automobile is disclosed. Using a portable self-charging power module and electrical system, to power a compressed hot-air system, and delivering the air to a hot-air distribution system, which replaces spark and glow plugs, with pneumatic injector nozzles. When the hot compressed air is delivered to an engine and mixed with the cooler static air it causes a violent reaction which drives the piston downward, another version uses compressed air and hydraulic fluid which compresses a plunger upwards. This movement causes crank-shaft to rotate, and engine to operate.

### DESCRIPTION OF RELATED APPLICATIONS

This Application is a conversion of Provisional Application Ser. No. 60/485,414, filed on Jul. 08, 2003, and a continuation-in-part of Co-pending application Ser. No. 10/811,382 filed on Mar. 27, 2004.

### BACKGROUND OF THE INVENTION

This version of the invention is concerned with the field of pneumatic and fluid engines for use in the transportation industry. More specifically this version of the invention also covers the systems that makes said engines work, such as a DC to AC electrical power module, a high pressure hot-air manufacturing device, and a pneumatic delivery system.

1. Prior Art

While some attempts have been made to make pneumatic engines for toy cars as is exemplified in U.S. Pat. No. 6,006,517, Pneumatic Engine, issued to Charles D. Kownacki and Jeffrey G. Rehkemper and Ronnen Harary on Dec. 28, 1999. Attempts have also been made to use bottled air and gas to power automobiles. However such attempts are limited as to range and speed, and some of said vehicles are banned from bridges and tunnels due to their combustible and explosive agents.

What is needed therefore to fill this need is the development of a system that is fuel-free, and pollution free, non-toxic, non-explosive, non-combustible and non-corrosive, and safe. Accordingly such a system should be able to be used to promote Air, land, and marine transportation.

2. Discussion of the Prior Art

The reason pneumatic energy has not been used successfully to promote travel in general is the fact that it requires high electrical energy to produce it, and present battery power alone is not sufficient to accomplish this task. What is needed therefore to overcome this limitation is a way to convert present DC battery power to higher AC electrical energy.

A variety of devices are on the market that uses battery power to convert DC current to AC current, but they all suffer from many limitations, for example they are only useful for a short time, and for limited usage, as is exemplified in U.S. Pat. No. 5,077,652, Dual Feedback Loop DC-To-AC Converter, issued to Brian J. Faley on Dec. 31, 1991. This device will stop when the batteries are discharged, or it must have some other outside source of power for continual operation. What is needed therefore to overcome these limitations is a way to refurbish the batteries as they are used, allowing the converted power to be useful on a continuous basis, and to be used for a greater variety of load applications, including the transportation industry.

Attempts are continuously being made to fill this need as is exemplified in U.S. Pat. No. 5,804,948, System for Zero Emission Generation of Electricity, issued to John W. Frost on Sep. 8, 1998.

As illustrated by background art, efforts are continuously being made in an attempt to develop ways to re-charge batteries of said devices as they are used, thereby allowing the said converted AC current to be applied to a load for a longer time period. However this attempt fall short of its intended purposes, as the system of Frost's invention would operate for a shorter time period than battery power alone. Frost's invention will not achieve its intended goal for the following reasons: Frost shows 2) 12-volt deep cycle batteries, a 12-volt-90-Amp automobile type alternator, and a I/4-HP-12-volt DC motor, and a 9500-watt DC inverted AC generator, a comptroller, plus relays and switches. One battery at a time is used to operate the system, while the other is in a charging cycle usually for four hour intervals, using said alternator to accomplish the charging process. According to Frost, said battery would be 50-percent discharged prior to re-charging. The problem with that is that an automobile type alternator is not designed to re-charge a discharged battery. This must be accomplished by a trickle type or slow charger. Since the amp/hour re-charge rate is usually slower that the amp/hour discharge rate, it is takes four hours to discharge said battery, it would take more than that to achieve a proper re-charging of said battery. In addition frost is using a ¼-HP-DC motor to drive both a 9500-watt generator and a 12-volt automobile type alternator, at the same time. During my research I spoke to an expert business owner who operates and alternator repair and sales Company, he told me that in his test a 5-HP motor was not sufficient to turn a 12-volt automobile alternator while is was in a charging cycle. So then, when said alternator of Frost's invention begins to charge, said motor would shut down from an overload, and Frost's system would come to a stop. In addition since Frost will be operating said alternator continuously without any break periods, as it continuously charges one battery then the next, said alternator would burnout prematurely, thereby ending the charging process and bringing his system again to a stop. Frost further states that having two batteries would allow a back-up in the event one battery becomes defective; however if the battery that is operating the system became defective, the battery that is being charged, might not be charged enough to operate the system, and that would render both batteries useless. As a result the system would come to a stop for the third time. In addition to all that's previously stated, Frost's invention violates the combined mass-energy conversion law, and the second law of thermodynamics. It takes 14-volts to re-charge a 12-volt battery, and Frost will be using one 12-volt battery to accomplish this and run the generator at the same time to do useful work, therefore friction would bring it to a stop, and this for the forth time. Frost's invention in reality will not achieve its intended goal, due to its poor design and improper use of component parts. No prior effort provides the benefits attendant with the present invention. As such, it may be appreciated that there is a continuing need for a new and improved system to replenish batteries of a battery operated device. In this respect, the present invention substantially departs from the conventional concepts, and designs of the prior art, and in so doing provides a system that substantially fulfills this need. Additionally, the prior patents and commercial techniques do not suggest the present inventive combination of component elements arraigned and configured as described herein.

The present invention achieves its intended purposes, objects, and advantages through a new, useful and unobvious combination of methods steps and component elements, with the use of a minimum number of functioning parts, at a reasonable cost to manufacture, and by employing only readily available materials.

### SUMMARY

The present version of the invention, which will be described in greater detail hereinafter, relates to the field of transportation devices. More specifically, this version of the invention is concerned with pneumatic and fluid automobile engines, and a conversion package for percent internal combustion gasoline engine. The said conversion package will convert the said gasoline automobile engines to a fuel-free and pollution-free engine. My version of the invention overcomes all of the shortcomings listed previously, in addition to novel aspects that will be described in detail hereinafter.

Described according to a typical embodiment, the invention presents a pneumatic compression conversion engine, for present gasoline engines, and a hydra-pneumatic compression engine that could replace the present diesel engines. There are three basic systems that makes these engines possible. The first is a power module and AC electrical system. The second is a hot compressed-air manufacturing system, and the third is a pneumatic delivery system.

The first system of the present invention which incorporates a modified version of a perpetual motion fan module which was described in continuation-in-part Co-pending application Ser. No. 10/811,382 filed on Mar. 27, 2004, to develop a continuous operating power module; which relates to the field of devices that uses battery power to convert DC current to AC current. More specifically, this portion of the invention is concerned with a battery operated automatic self-charging power module, which is used to operate a AC generator. The said device will deliver 110 and 220-volt continuously, with the option of incorporating a 220 to 440-volt transformer to deliver 440-bolts. My version of the invention overcomes all of the shortcomings listed previously, in addition to novel aspects that will be described in detail hereinafter.

Described briefly, according to a typical embodiment, the invention presents an Automatic Self-charging Power Module, for the purpose of delivering continuous, steady, portable, emission free, and fuel free 110, 220 and 440-volts AC. The said AC current can be used for a variety of applications, like being a power source for the transportation industry, and relieving electrical power plants and transmission lines, by supplying electrical energy to private consumers who can own their own power plants for their personal, residential, commercial, and industrial needs, and for suspended highway systems. The present invention can also help to alleviate energy shortages, and bring down the high cost of energy. In addition it can help to rid the planet of dangerous pollution from spent fuels, and save money to consumes, which will also help the world's economy. The device is comprised in general in a base or housing of non-conductive material like wood, in an order to keep the grounds of the separate circuits from crossing, and control panels with switches meters lights, and a display screen, and including the following components: 4) 12-volt deep cycle batteries, two which are connected in series to give 24-volts, and is used to operate the device, and two which are connected in the same manner and is used as a back-up power source. Two 24-volt-1-HP DC motors which are wired to operate in a counter-clockwise rotation, and supplies the turning motion for the system. Two chain and sprocket drive assemblies reducing to a 7-1 torque ratio, thereby supping the equivalent of 14-HP torque output to the drive load shaft. Two 12-volt-90-amp alternators to refurbish said main batteries separately, using double pulleys and drive belt assembly on a common drive shaft. Two 110-volt AC to 12-volt DC trickle type or slow chargers which refurbishes and re-charges the said back-up batteries separately. The device also includes a 50,000-Watt-AC generator delivering 110 and 220-volt-AC, and an optional 220 to 440-volt-AC transformer, delivering 440-volts-AC. In addition the present invention includes a CPU which monitors, and controls the system. Said CPU can turn the device on and off automatically in order to refurbish said batteries, when the device is not in use. The said CPU, can bring said back-up batteries in and out as needed.

As said device is operated, said motors transforms the electrical energy from main batteries into turning motion. Said turning motion is transmitted to main drive shaft, via said chain and sprocket drive assemblies, or similar means, and operates said AC generator, and said alternators simultaneously. Said alternators converts turning motion back to electrical energy, which is used to refurbish said batteries, separately on a as needed basis. As this process is repeated said AC power is used as needed, and the device is kept in continual operation. While some energy is lost due to friction, this is offset by the fact that both batteries together can produce more electrical energy than is needed to operate the system, hens said friction can be overcome. While the law of energy conversion asserts that one can only get as much energy out of a machine as is put into it, the present invention has devised an exception to this rule. This is my explanation; since it takes 24-volts to operate the system, and each 12-volt alternator can produce 14.95-volts, this would mean we are using 24-volts to produce 14.95-volts, this does not violate the law of energy conversion. Now if you were using 12-volts to produce 14.95-volts it would. Now here is the exception, since we are duplicating this with the same turning motion, and we can do this with the same drive shaft and pulley, and since we have enough torque and velocity to achieve this, we can add the value of both alternators and get 29.9-volts this from 24-volts and we would not be violating any laws; since in doing so we will have enough electrical energy to operate the system, and overcome friction, and re-charge the batteries, as long as we keep the friction to a minimum. There are some ways we can keep friction to a minimum. If all major parts as possible were to operate in a counter clock-wise rotation, friction would be reduced, as they would be turning in concert with the Earth's rotation. One can notice this principle in action as water drains from a full bath tub, as it begins to empty the water will rotate in a counter-clockwise motion on its own, in concert with the Earth's rotation. Another way to reduce friction is to ensure that all corresponding mating parts are in complete alignment, and all parts are properly installed and properly adjusted.

The second portion of the invention is concerned with the field of conventional air compressors. More specifically my version of the invention is concerned with a modified version of compressed air devices that incorporates a jacketed insulated storage tank with an heating element, a thermostat, and temperature and pressure relief and recording devices, and an outlet air filter. The said device is modified for a new unobvious use, to deliver high temperature, high pressure, and high C.F.M. pneumatic energy to an engine to create movement.

The third portion to the present invention introduces a new concept to the market place, that uses hot compressed air in the place of gasoline, to operate a gasoline internal combustion engine. According to a typical embodiment this portion of This invention presents an insulated air distributor canister, with a heating element and temperature and pressure control, and recording devices. Included also are ports with valves, and air hoses, and pneumatic nozzles, which replaces conventional spark plugs, and a pressure regulating device.

The said DC to AC power device supplies the high electrical energy to the said hot air manufacturing system, which in turn supplies the pre-heated pneumatic energy to said air distributor canister. Said air distributor canister re-heats and distributes said pneumatic energy to the original engine block, through said pneumatic injector plugs, in response to the engine firing order.

The present version of the invention, involves a new science which JESUS & Bailey International foundation calls Pneumassism. More specifically Pneumassism is the study of what we call a “Pneumassis Reaction”. By definition JESUS & Bailey States: When air or gasses of varying temperature, volume, pressure, and velocity, are suddenly mixed under certain conditions, they can cause a nature phenomenon uncontrolled violet reaction. Such uncontrolled violent reaction can be seen in a tornado, cyclone, or hurricane. Accordingly if one can simulate these conditions in a controlled environment such as an engine, said violent pneumassis reaction can be used to create motion and propulsion, for land marine and air travel. The said motion can also be used to generate electricity.

My version of the invention, resides not in any one of these features per se, but rather in a particular combination of all of the them herein disclosed. It is distinguished from the prior art in this particular combination of all of its structures, for the functions specified.

In order that a detailed description of the invention may be better understood, and that the present contribution to the art can be more fully appreciated, additional features of the invention will be described hereinafter. It should be appreciated by those skilled in the art that the conception and the disclosed specific methods, and structures, may be readily utilized as a basis for modifying or designing other structures, for carrying out the same purposes of the present invention. It should be realized by those skilled in the art, that such equivalent methods and structure do not depart from the spirit and scope of the invention.

In this respect, before explaining at least one embodiment of the invention in detail, it is to be understood that the invention is not limited to the details of construction, and the arrangements, of the components, as set forth in the following description, or illustrated in the drawings. The invention is capable of other embodiments, and of being practiced and carried out in various ways. Also, it is to be understood that the phraseology, and terminology employed herein, are for the purpose of description, and should not be regarded as limiting.

As such, those skilled in the art will appreciate that the conception, upon which this disclosure is based, may readily be utilized as a basis for designing of other structures, method and systems for carrying the several purposes of the present invention.

Further, the purpose of the foregoing abstract is to enable the U.S. Patent and Trademark Office, and the public generally, and especially the scientists, engineers and practitioners in the art, who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

The invention refers to certain values of volts, amps, watts, horse power, ratios, P.R.M., temperature, pressure and such like. These values are mealy to demonstrate the usefulness of the present invention, and they are not intended to be limiting in any way. As such, said values may be changed at any time, and other values may be resorted to falling within the scope of the present invention.

Accordingly, it is an object of my version of the invention to provide a low-cost, east-to-manufacture, and easy-to-market pneumatic engine and conversion package.

A further object of my version of the invention is to provide an easy-to use and versatile and light weight hot compressed air device for the transportation industry.

A significant object of the invention is to provide a power module that can maintain its self when it is not in use, and can be serviced to some degree without interruption of service when in use.

A final but very significant object of the invention is to provide a Pneumatic distribution system that can replace spark plugs and gasoline for use in the transpiration industry.

For a better understanding of the invention, its operating advantages and specific objects attained by its uses, references should be made to the accompanying drawings, and descriptive matter, in which there is illustrated a preferred embodiment of the invention. The foregoing has outline some of the more pertinent objects of the invention. These objects should be construed to be merely illustrative of some of the more prominent features of the present invention. Many other beneficial results can be attained by applying the disclosed invention in a different manner, or by modifying the invention within the scope of the disclosure. Accordingly, other objects and a fuller understanding of the invention may be had, by referring to the summary of the invention, and the detailed description of the preferred embodiment, in addition to the scope of the invention illustrated, by the accompanying drawings.

### BRIEF DESCRIPTION OF THE DRAWINGS

The foregoing and other objects, features and advantages of the invention will become more fully understood from the following description of the preferred embodiment of the invention, as illustrated in the accompanying drawings, in which like reference characters refer to the same parts throughout different views. The drawings are not necessarily to scale, emphasis instead being placed upon illustrating the principles in the invention.

FIG. 1 is a perspective view of a continuous operating battery operated automatic self-charging power module illustrating and inter-relationship of major component parts.

FIG. 2 is a perspective view of said power module illustrating main wiring configuration, and showing its separate circuits inter-relationship.

FIG. 3 is a perspective view of said mention power module showing transformer and back-up battery wiring arrangement.

FIG. 4 is an elevation view of a hot compressed-air manufacturing device for an automobile pneumatic engine, the drawing illustrates how the device could fit in a tire-well of a truck of an automobile and has a soundproof cover.

FIG. 5 is an elevation view of a larger hot compressed-air device modified for the transportation industry, and can be used in larger vehicles, the device includes a soundproof cover.

FIG. 6 is a perspective view showing a hot-air distributor with its component parts.

FIGS. 6A & 6B illustrates alternate embodiments of a hot-air distribution system.

FIG. 7 is a perspective view illustrating a possible positioning of a hot-air distribution system showing accelerator linkage connection.

FIG. 8 is an elevation view of a proposed mini-van with storage compartments for power module and hot compressed-air manufacturing device.

FIG. 9 is a schematic diagram of a conventional internal combustion gasoline engine with a pneumatic engine conversion package installed, usually 100 to 220-volt AC wiring configuration.

FIG. 10 is a perspective view of a hot-air distribution system for a hydra-pneumatic engine in accordance with the present version of the invention.

FIG. 11 is a side elevation view of the internals of a hydra-pneumatic-compression engine in accordance with the present version of the invention.

FIG. 12 is a end elevation view of a hydra-pneumatic-compression engine block in accordance with the present version of the invention.

FIG. 13 is a plan view of a hydra-pneumatic-compression engine arrangement in accordance with the present version of the invention.

FIG. 14 is a perspective view of a proposed bus showing storage compartment for power module and electrical system and hot compressed-air manufacturing device.

FIG. 15 is an elevation view of a proposed dump truck showing storage cabinet for power module and electrical system and hot compressed-air manufacturing device.

### DESCRIPTION OF THE PREFERRED EMBODIMENT

Description

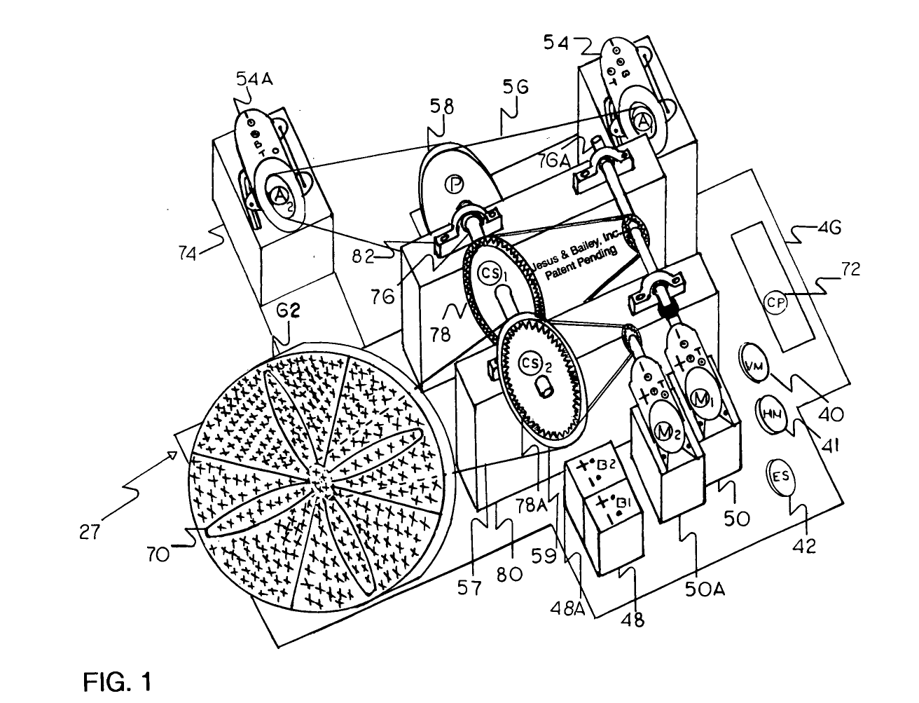

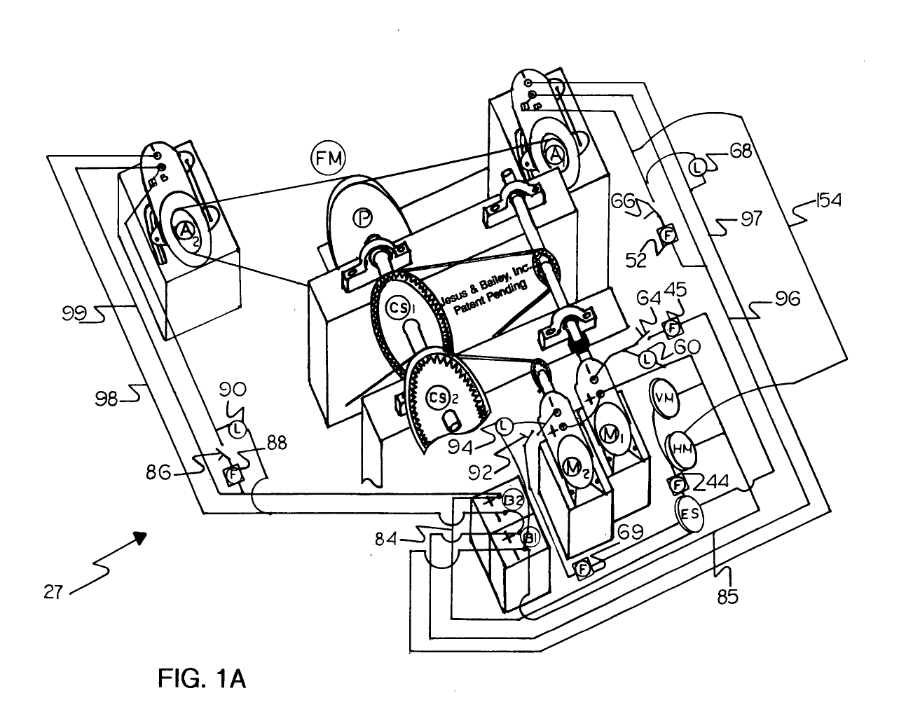

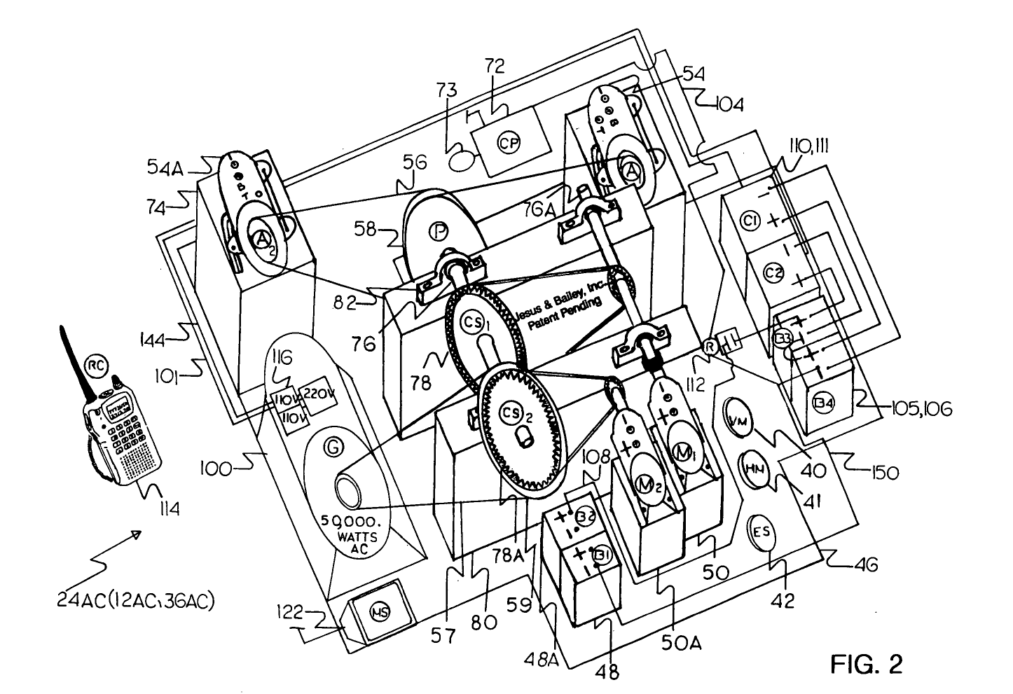

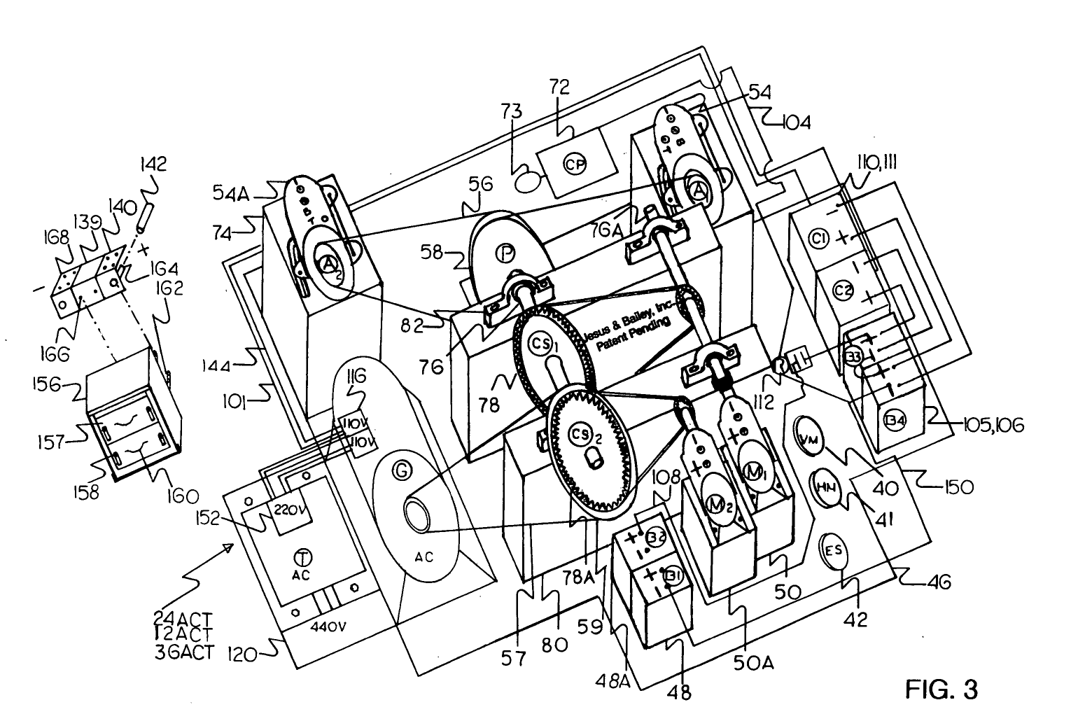

Referring now to the drawings and, in particular, to FIGS. 1 & 1A wherein there is illustrated a typical embodiment of the perpetual motion fan module 27, claimed in Co-pending application Ser. No. 10/811,382. The said fan module 27, as shown in FIG. 1A is modified as illustrated in FIG. 2, as 24AC(12AC & 36AC) to include a 50,000 watt AC generator 100, which is secured to base 46 by appropriate hardware, and delivering 110/220-volt to a load, in place of fan 70 (FIG. 1). Included also in the invention hereafter mentioned as 24AC, is a battery back-up system, including two 12-volt batteries 110 & 111 respectively. Additionally two 110-volt-AC to 12-volt-DC battery charges 105 & 106 respectively, all secured to base 46 by appropriate hardware, to charge said back-up batteries as needed. Included also as part of the invention 24AC, is a computerized system 72, connected to monitor 122, and speaker 73, and also secured to base 46 by appropriate hardware. Computer 72 receives power from main batteries 48 & 48A, and have its own back-up battery, which is re-charged by said device. Additionally a remote communicator/controller 114 is also included. All materials are light weight, and all motors are low noise. This version of the invention uses chain and sprocket drive mechanisms 78 & 78A, installed as illustrated in FIG. 1, however the more quiet polyp-chain drive equipment can be used instead, or any suitable rotary drive mechanism. Accordingly all drive pulleys can be made of steel or plastic or other suitable composite materials. The base and enclosures are made of non-conductive materials such as wood or plastic of fiber glass, or any such suitable composite materials, or a combination thereof. Alternators 54 & 54A are standard 12-volt automobile type, but other suitable charging components may also be used. There are three separate DC circuits, in device 24AC, and their grounds must not cross connect. Furthermore all AC circuits must not cross connect with DC circuits. Additionally all electrical codes must me followed, and all safety devices must be incorporated where applicable, including, but not limited to the following: Ground fault interrupters, lightning restores, circuit breakers, and such like. Referring now to FIG. 3 wherein there is illustrated a further modification of the invention as, 24ACT, which includes a 220/440-volt AC, transformer 120, which delivers 440-volts to a load, and is installed as a part of device as shown, and secured by appropriate hardware. This allows the device 24ACT, to deliver 110, 220, & 440-volts to a load. Additionally the present version of the invention 24ACT includes a quick change battery consul 156, which is made of non-conductive materials such as plastic or any such composite materials. The device 156 faculties a quick changing of main batteries, if needed, and has front non-conductive tumbler locking handles 158 which is connected to terminal tumblers 162, and battery terminals are connected to it internally, and battery is secured to compartment 157 by appropriate hardware. Terminal tumblers 162 mates and interlocks with rear external terminal tumblers 164, which gives power to external rear positive and negative terminal plates 140 & 168, which is secured to consul 156 by hardware 66. Non-conductive spacer 139 separates both terminals, and insulation sleeves 142 covers tumblers 164.

Referring again to FIG. 1A The position of all three DC circuits should be noted as illustrated by the drawing, in order to prevent cross grounding, of said circuits. Wire 84, is 24-volt Main positive, and wires 85 is 24-volt Main negative. Wire 96 is 12-volt positive, and wire 97 is 12-volt negative, to alternator A1. Wire 99 is 12-volt positive, and wire 98 is 12-volt negative to alternator A2. The manual sequence of operation is as follows. Ensure that batteries (B1 & B2) are fully charged, then energize motor (M1) by closing switch 64. Motor on light 60 should cone on, and system should be set in motion. After 30 seconds energize motor (M2) by closing switch 92, motor on light 94 should come on. Both alternators (A1 & A2) will be in motion. Next close exciter switches 66 & 86, both alternators will be excited and ready to charge each battery separately, through their internal voltage regulators. This process will allow the device 27 to operate indefinitely without need for a separate charging process for batteries 48 & 48A.

Referring again to FIG. 2, the previously mentioned process will also set AC generator 100 in motion and ready to supply 110 and 220-volts to a load. Back-up batteries 110 & 111, will be put in operation by computer 72, via relay 112, should main batteries 48 & 48A, malfunction or fail to hold a charge, or needs a temporary booster. While system is on back-up power, computer 72 will send an alarm through speaker 73, and remote communicator/controller 114, and monitor 112 will display a message telling that main batteries needs to be replaced. The computerizes system 72 can also give voice instructions and commands. Device 24AC can also be turned on and off by remote 114, and monitor 122, by touching the screen, and buttons at appropriate contacts. Both remote 114, and monitor 122 can display all functions, and show all values and problems of the invention 24AC. When device 24AC is in the off position. Computer 72 monitors the condition of said main and back-up batteries, and can turn the device 24AC on to re-charge said batteries, then turn the device 24AC off once said batteries are fully charged.

Referring again to FIG. 3, 24ACT, While the present invention is on back-up power, the main batteries can be changed without shutting down the system by the use of the quick change battery consul 156, no tolls or mechanical nor electrical ability is needed to perform a battery change. Rotate terminal locking handles 158 ¼ turn outwards, and pull handle 160 out removing battery compartment 157 with battery in place. Install another battery compartment with new battery in place and rotate tumbler locking handles 158 ¼ turn inwards and battery is ready for use (a 12-volt consul would have one compartment, and a 36-volt consul would have three battery compartments). The present invention illustrates a 24-volt system. The present invention can be made as 12AC & 12ACT, also 36AC & 36ACT. A 12ACT will be 12-volt DC delivering 110/220/440-volt AC to a load. A 36ACT will be 36-volt DC delivering 110/220/440-volt AC to a load. A 12AC will have two 6-volt batteries, and two 6-volt charging components, to charge each battery separately, and back-up batteries will have the same. A 36AC, will have three 12-volt batteries and three 12-volt charging components to charge each battery separately, and the back-up batteries will have the same.

The present version of the invention as illustrated in FIGS. 2 & 3 can be used for multiple purposes, such as but not limited to, supplying AC current for residential, commercial, and industrial use, and also to power electric automobiles, and devices. However for the purposes of this invention these uses are not being explored. But will be in additional applications. Additionally the present invention shows values of Volts, amps, watts, horse power, and such like, these values are merely for examples, and should not be regarded as limiting in any way, and other values may be resorted to falling within the scope of the invention.

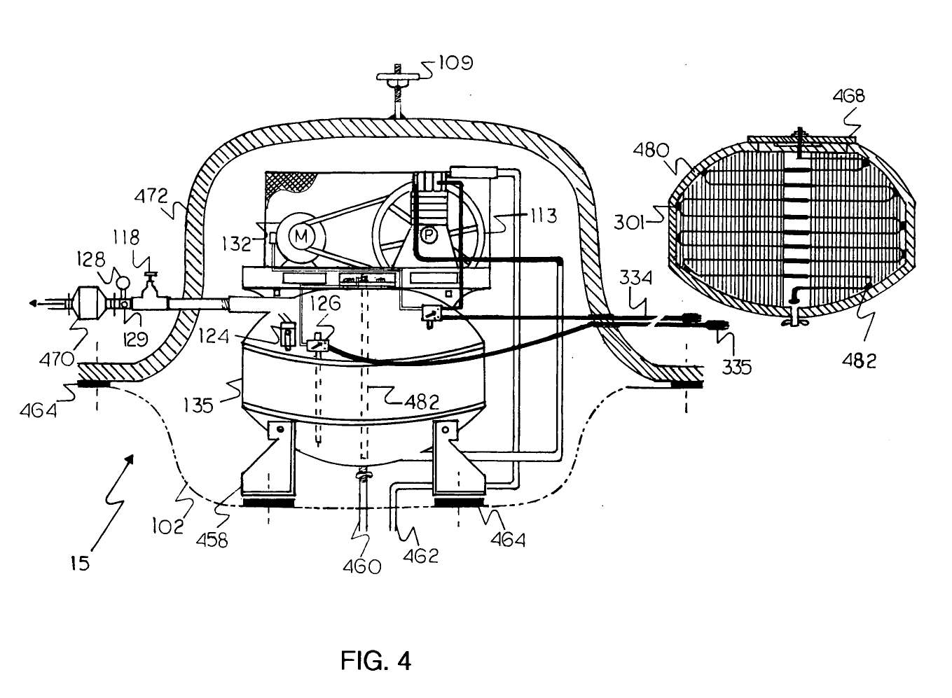

Referring now to FIG. 4 wherein there is illustrated a typical embodiment of a light weight low noise high pressure and temperature air manufacturing device 15, of pressure and temperature enough to cause a pneumassis reaction under the right conditions. The present version of the invention 15 is constructed of materials and components that are light weight and durable, and resistant to corrosion and oxidization, such as aluminum, fiberglass, plastic, carbon steel, stainless steel, various composite materials or a combination thereof. The invention presents a conventional type air compressor, made of light weight materials where possible, and is designed to meet low noise standards, designed specifically for automobile industry use. The device 15 is also modified in the following ways: heating coil 482 is installed through access opening 468, with high temperature non-conductive spacers 301 between said coil and tank 135, so that coil 482 does not make contact with tank 135 at any point. A thermostat control 126 is installed to control the temperature of coil 482. Holding tank 135 is jacketed and insulated. Temperature and pressure relief 124 is also installed as a safety device. Device 15 is also designed to fit into the tire well of trunk of standard automobile. Sound proof cover 472 made of non-conductive material is provided, with bolt and nut 109 for securing donut type spare tire on top of said cover. Shutoff valve 118 and pressure and temperature gauge 128 is provided, along with air-filter 470. Snap-On type air hose connection 129 is also provided for general use, for things like pumping tires and such like. Air-intake hose 462 is installed to outside of vehicle and hole around hose is sealed water tight. Drain hose 460 is installed in the same manner. Rubber spacers 464 is installed as shown to hold-down locations with appropriate hardware.

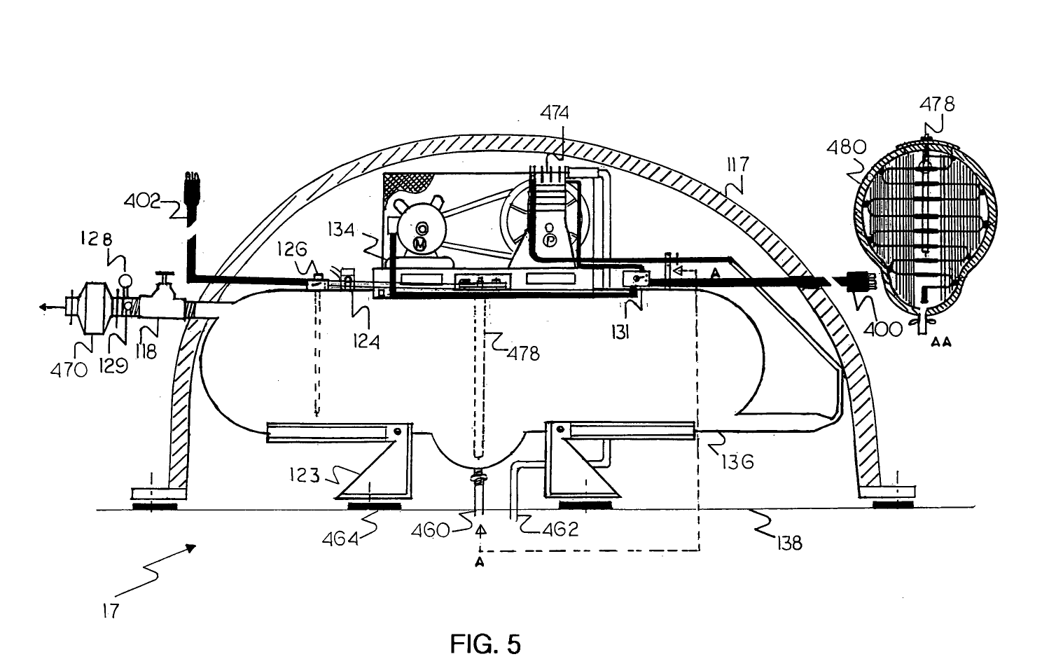

Referring now to FIG. 5, therein illustrated is a typical embodiment of a compressed hot-air system 17. The present version of the invention 17 is the same as device 15 FIG. 4, except it has a larger motor and pump and storage tank. More specifically the invention 17 has a 440-volt-AC motor 134, to deliver more CFM of heated pneumatic energy than device 15, and is for a larger vehicle.

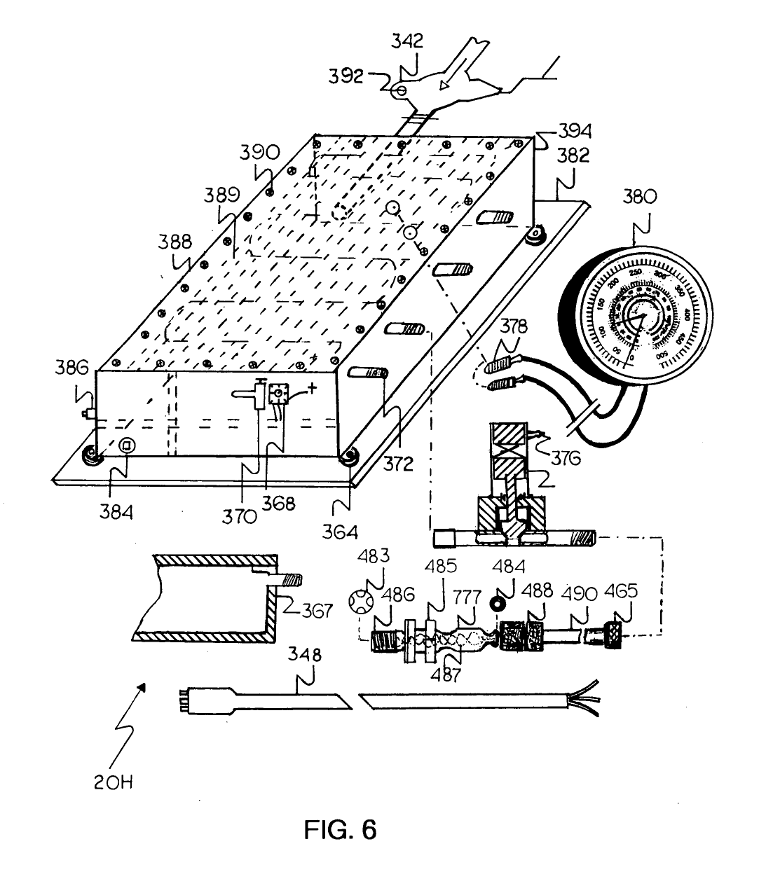

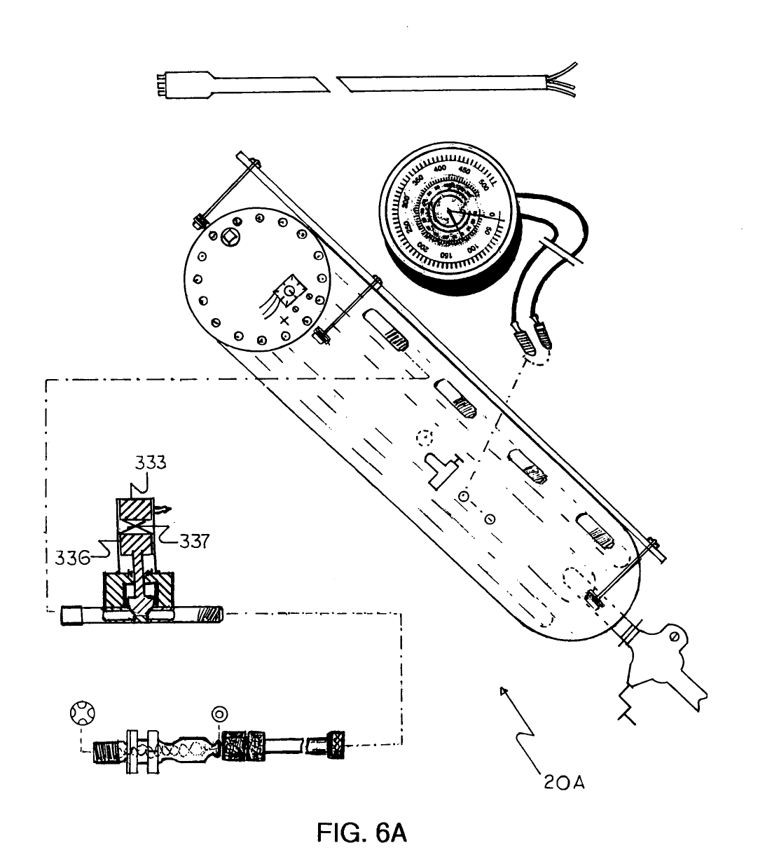

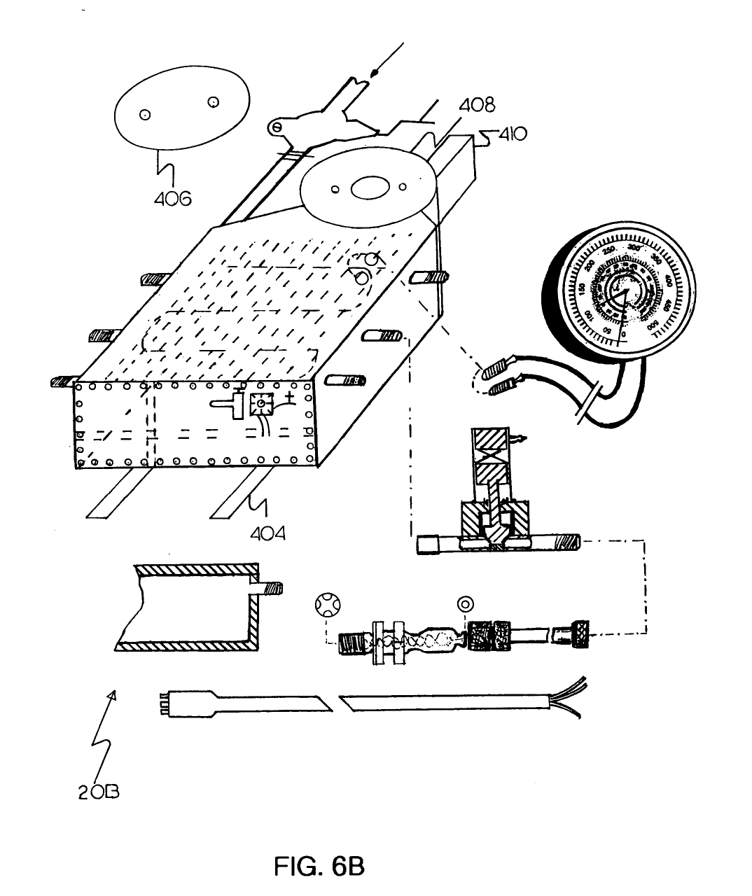

Referring now to FIG. 6 therein illustrated is a typical embodiment of high temperature and pressure pneumatic energy distribution system 20, hereafter referred to as system 20. The present version of the invention system 20 is constructed of materials and components that are light weight, durable and resistant to corrosion and oxidization, such as aluminum, carbon, stainless, and mild steel, plastic, fiberglass, various composite materials, or a combination thereof. The device system 20 consist of a energy distribution canister 394, which is jacketed and compressed with thermal insulation 367. Canister 394 has output ports 372 at top, and input port at bottom to receive inlet air regulator 342, with adjusting set screw 392. Ports 372 can be for four cylinders and up, and are threaded to receive air admittance valves 377 or 379 (EZ12 or EZ24) for 12 or 24-volt coils, hereafter referred to as EZ-valves. EZ valves also has push-on connection 376 designed to accept original spark plug wires. The other end of said EZ-valves screws to insulated thermal high pressure air hose 490. The other end of air hose 490 has Snap-On type connector 488, which connects to pneumatic injector plug 777, hereafter referred to as plug 777, which replaces engine spark plugs. Plug 777 has internal spiral flutes 487 which causes air to spin in a counter clock-wise rotation as it exits the plug, at nozzle orifice 483. Plug 777 also has “O” ring seal 484 at compression end to ensure a air tight seal. Canister 394 has cover 388, which is secured by appropriate hardware, with gasket and seal to withstand appropriate operating temperature and pressure. In addition system 20 has heating coil 389, installed with thermal spacers to prevent contact with canister 394. System 20 also includes temperature control device 368, and temperature and pressure relief device 370, and threaded boss 369 for grounding to engine block. Drain ports 384 & 386, allows system 20 to drain canister in horizontal and vertical positions. Mounting plate 382 is secured to canister 394 by appropriate hardware with thermal rubber spacers to prevent heat transfer to engine block. Instrument gauge 380 is also provided to show operating pressure and temperature, and is installed into canister 394 at ports 378 as shown. Gauge 380 is installed in dash of auto at any convent spot. Power cord 348 is also provided, and is wired to thermostat 368, and the other end plugs into electrical system.

Referring now to FIG. 6A wherein illustrated is an alternate embodiment of a high temperature and pressure pneumatic energy distribution system 20A. The present version of the invention system 20A has all of the characteristic of System 20, FIG. 6, but is a cylinder shape type canister. System 20 can be made of any size, shape, or for any number of engine cylinders. EZ-valves can be made in any manner that will facilitate the desired pneumassis magnet 333 can be for 12 or 24-volt DC, and faces permanent magnet plunger 336 north to south pole. Tension spring 337 keeps both magnets apart. When powered electric magnet 333 pulls permanent magnet 336 towards it opening EZ-valve. When power is removed tension spring 337 forces plunger 336 down closing EZ-valve.

Referring now to FIG. 6B wherein there is illustrated an alternate embodiment of a high temperature and pressure pneumatic energy distribution system 20B. The present version of the invention system 20B is the same as system 20 FIG. 6, except it is designed to fit automobiles with carburetors. Existing Carburetor canister will be discarded and System 20B will replace it where possible. System 20B can be made of any size or for any number of engine cylinders, to fit various vehicles. Carburetor air cleaner will for into canister 408, and cover 406 installed with proper hardware. Brackets 404 can be secured to any appropriate place on existing engine with appropriate hardware. Vent port 410 allows air to enter engine through air cleaner.

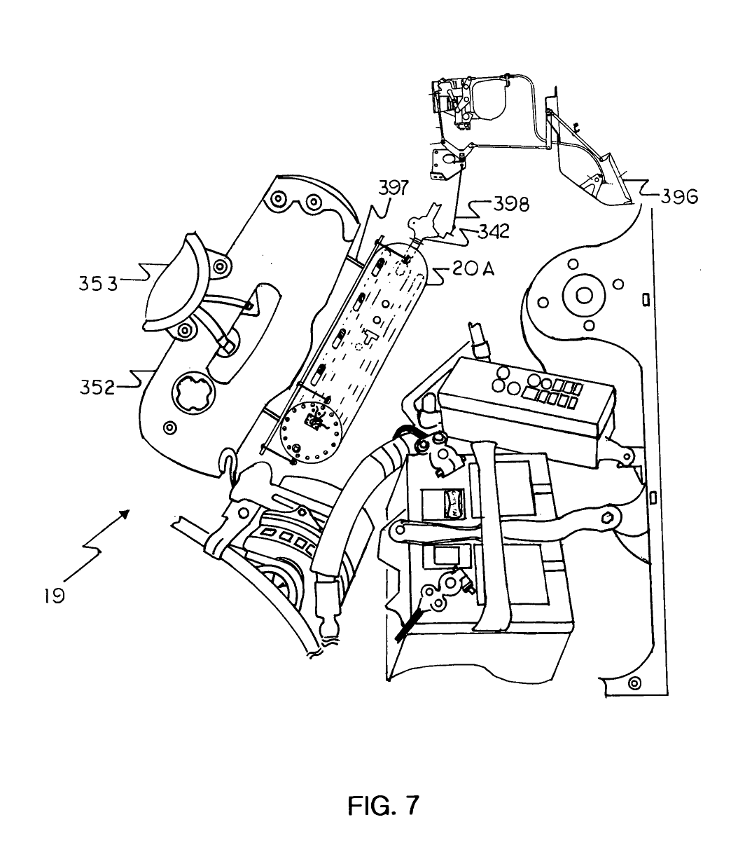

Referring now to FIG. 7, therein is illustrated a engine conversion installation 19, showing system 20A with mounting hardware 397, mounted to existing engine block 352. Accelerator linkage connection 398 is shown connected to air-regulator 342. Accelerator pedal 396 is also shown. System 20 can be installed at any convenient location close to engine, so that existing spark plug wires can be used. In event system 20 has to be located else where new longer spark plug wires may be installed.

Referring to FIG. 8 therein illustrated is a new design mini-van 16 The present version of the invention illustrates an example of the incorporation of a storage compartment for conversion package, in new vehicle design. Compartment 344 houses high pressure and temperature air-manufacturing device 15 (HPTA15) for short, and power module and electrical system 12AC (PME12AC) for short. Top compartment 346 is for luggage, with lift tailgate 360, for access.

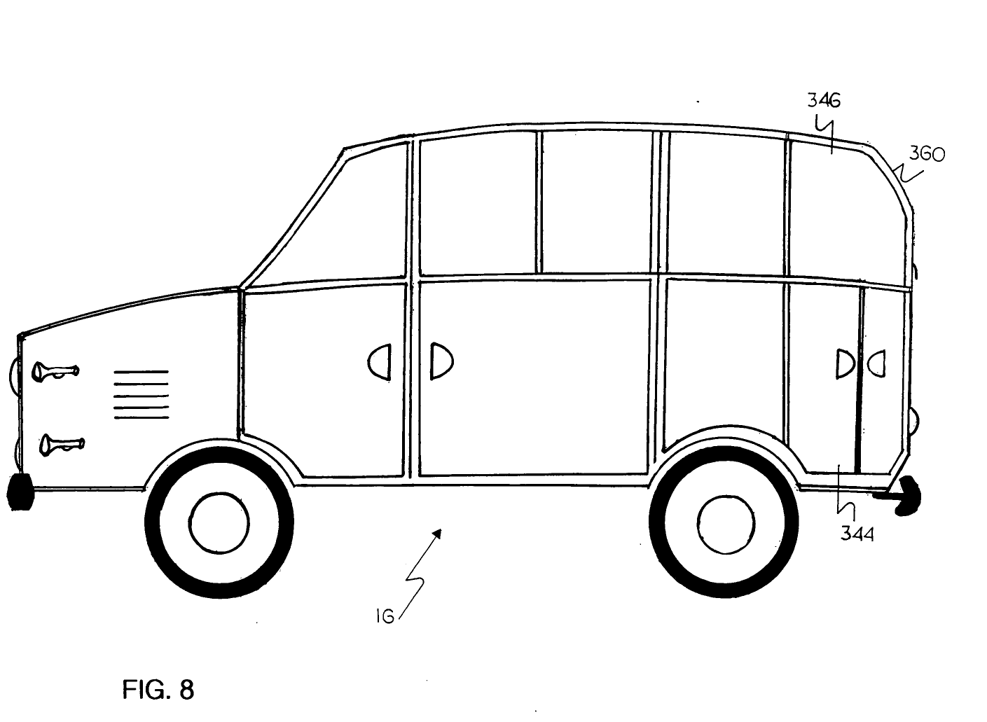

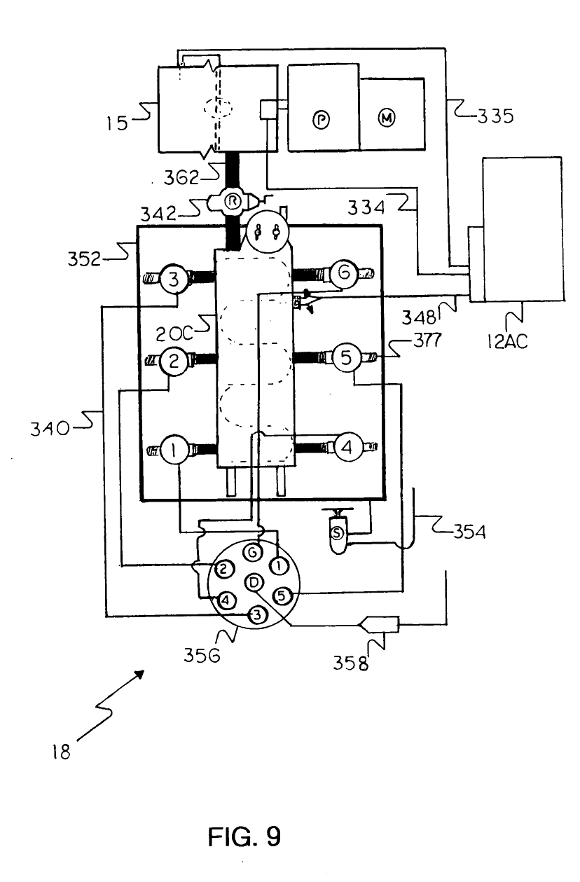

Referring now to FIG. 9 wherein there is illustrated a typical embodiment of a engine conversion schematic layout 18. The present version of the invention 18 shows system 20B mounted on top of existing engine 352, and connected to HPTA15, which is plugged into PME12AC. The air-pump motor is connected by cord 334, and heating coil is connected by cord 335. System 20 is connected by cord 348, which is also plugged into PME12AC.

In order to make a engine conversion, make sure gasoline tank is near empty as possible. Disable and crimp-off gas line from fuel pump. Remove high energy coil 358, and connect wire directly to distributor main (D). Remove spark plug wire from plug, and connect to corresponding EZ-valve, at locations 1 through 6. Next (reefer to FIG. 6) connect hose 490 to EZ-valve, and remove spark plug from engine and install plug 777, and snap on hose 490 to plug 777, at locations 1 through 6. Next install gauge 390 to system 20 and inside auto, as previously described. Next connect accelerator linkage as previously described. Engine is now ready to be tested.

Start PME12AC as previously described, and turn on HPTA15. When indicated temperature and pressure is reached on gauge 380, engine is ready to be started. Turn engine start key as usual, as intake valves bring cold air and engine compresses it, and distributor energizes EZ-valves sending high temperature and pressure air to cylinders, the sudden mixing of air of different temperature, volume, pressure, and velocity, causes a natural phenomenon uncontrolled violent reaction which (we call a pneumassis reaction) driving engine piston down, and causes movement of internal engine parts, which when repeated said action causes vehicle to self propel from one place to another. As accelerator pedal is depressed, air regulator pressure is increased, sending more pressure and volume to engine, and thereby increasing engine speed. Idle speed can be adjusted at air-regulator adjusting set screw 392 (FIG. 6). The present invention as described presents an improvement of conventional gasoline driven automobile, by converting said automobile to a safer, fuel-free, and pollution-free, and is a more cost effective way of transportation, as it presents no cost of fuel to the consumer user.

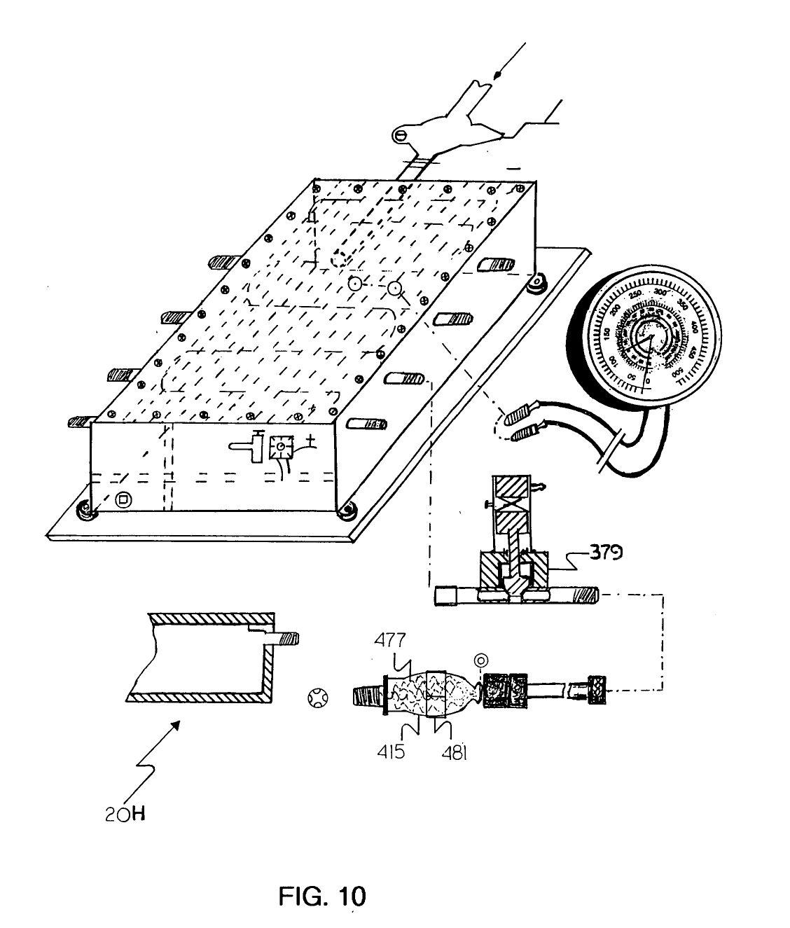

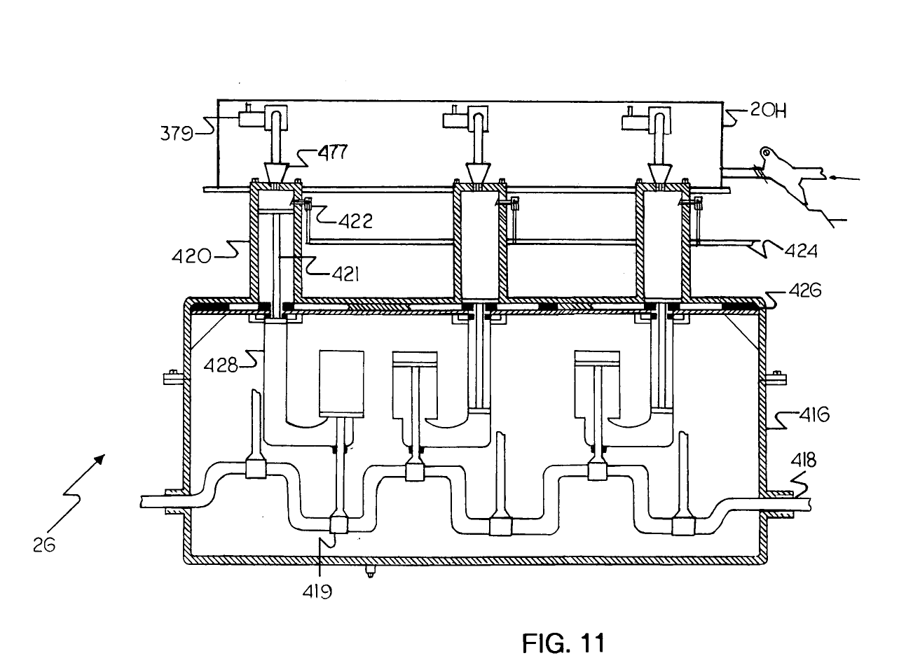

Referring now to FIG. 10 Wherein there is illustrated a typical embodiment of a system 20H. The present version of the invention 20H is a high temperature and pressure pneumatic energy distribution system for a hydra-pneumatic compression engine 26 (FIG. 11). The main differences with the previous system 20, is that system 20H is designed for heavy duty vehicles such as tractor trailers, dump trucks, each moving equipment and such like. System 20H is usually larger and is usually for more cylinders, and usually operates at higher pressures. Additionally system 20H usually uses 24-volt EZ-valves 379, and balloon plugs 477.

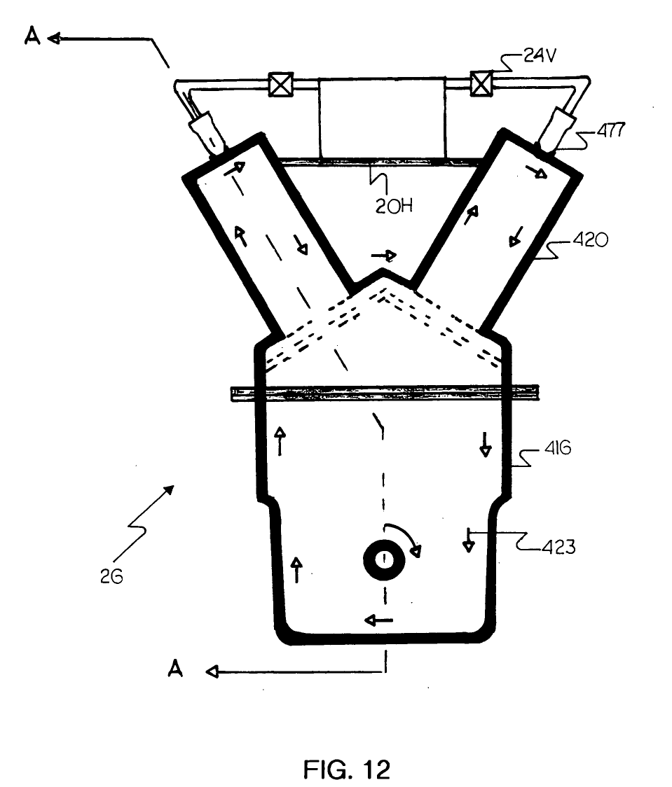

Referring now to FIG. 11, wherein there is illustrated is a typical embodiment of a hydra-pneumatic compression engine 26. The present version of the invention 26 is constructed of materials and components that are light weight, and durable and resistant to corrosion and oxidization, such as aluminum, stainless steel, carbon and mile steel, malleable iron casting, plastic, rubber, copper, various composite materials or a combination thereof. The engine 26 consist in the main crankcase house 416 of crankshaft 418, lift-rod and plunger 419, and fluid chamber 428. Crankcase 416 upper section consist of air-chamber 420, and air-piston 421, and compression and vent valve 422, and air-vent and re-cycle manifold 424. Superimposed on top of crankcase 416 is system 20H. Engine 26 is designed to replace conventional diesel engines, and has more torque output than the previous gasoline conversion package. FIG. 12 shows an end elevation view of engine 26. Arrows indicates direction of water flow in engine water jacket, and crankshaft rotation.

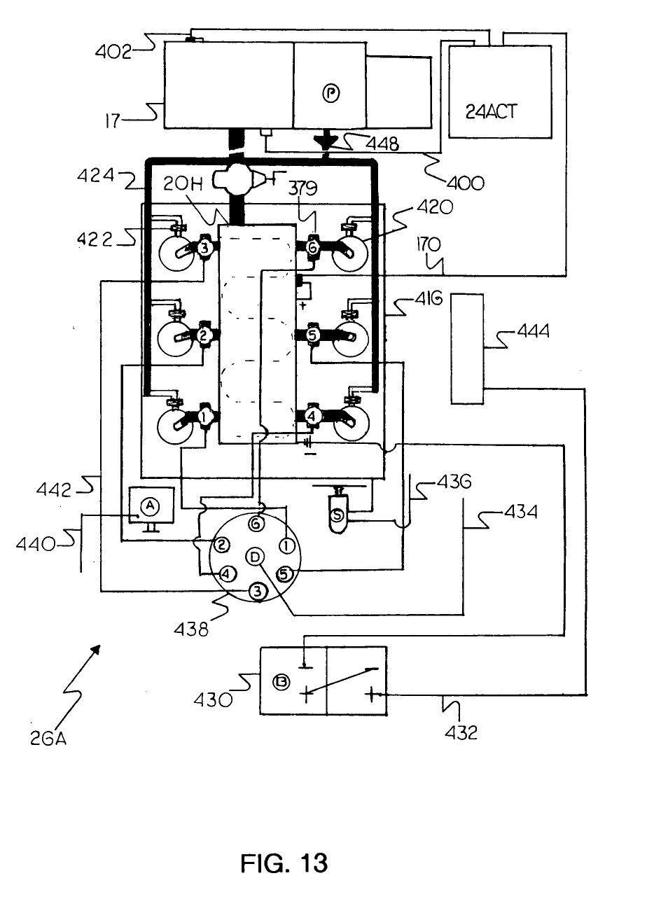

Referring now to FIG. 13 wherein there is illustrated a schematic layout of hydra-pneumatic compression engine 26A. The present version of the invention 26A illustrates all the systems that make engine 26 operate. High temperature and pressure air-manufacturing device 17 is plugged into power module and electrical system 24AC, by 440-volt power cord 400 for pump motor, and 220-volt power cord 402 for heating coil. System 20H is plugged into PME24AC by 220-volt power cord 170. Additionally engine 26A has a separate 24-volt battery 430.

Referring again to FIGS. 11 & 13, as engine 26A is started by starter 436 and distributor 438 sends 24-volts to EZ-valves 397, air enters air-chamber 420, via balloon plug 477, said action forces air-piston 421 downwards. As said air piston travels downwards hydraulic fluid in chamber 428 forces lift-rod 419 upwards, causing crankshaft 418 to rotate, said repeated action causes vehicle to self-propel from one place to another. The said result could improve existing automobiles, as no fuel would need to be purchased by operators, and no pollution would be produced in its operation, Even the clean air that is exhausted is re-cycled back to pump intake through exhaust funnel 448.

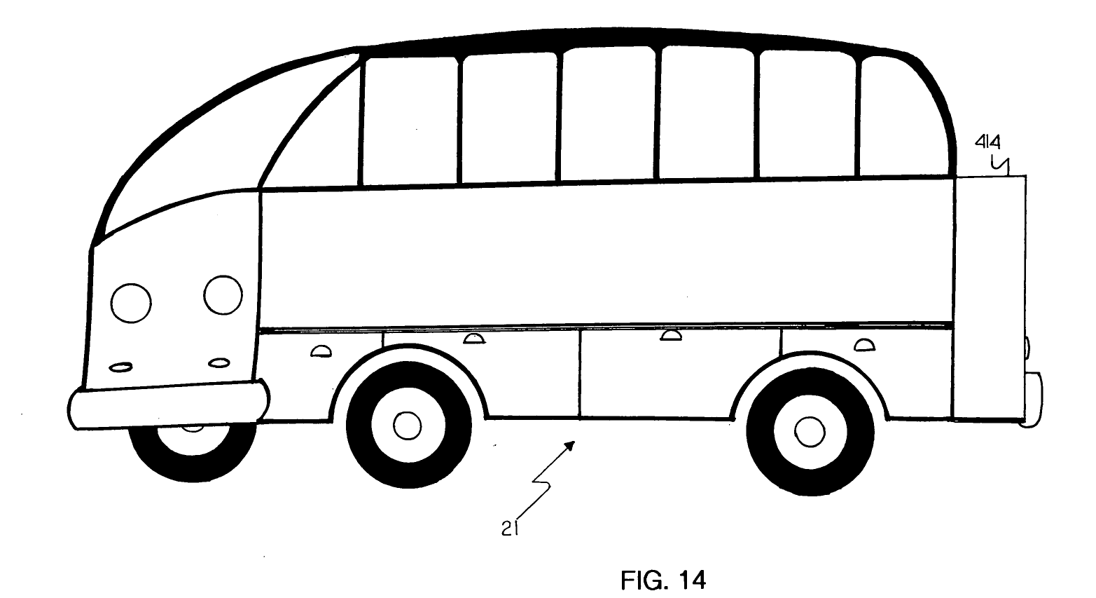

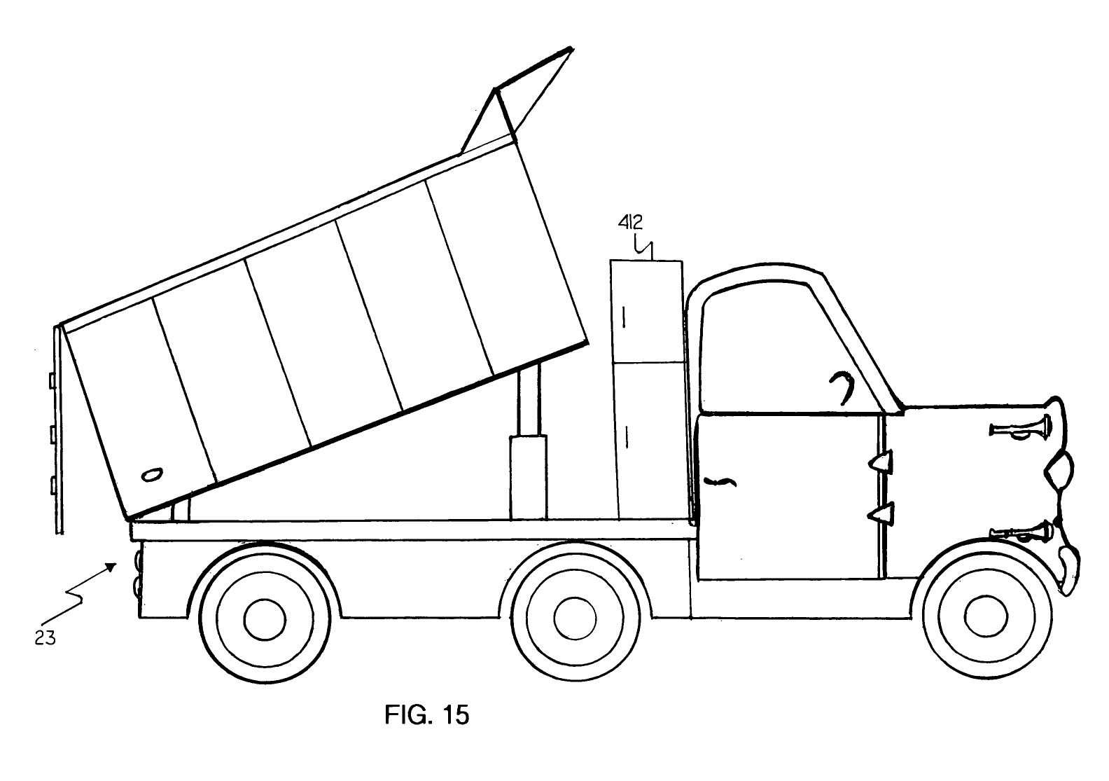

Referring now to FIGS. 14 & 14 wherein there is illustrated a modification or new design, which incorporates storage compartments designed to house engine conversion packages previously explained. It should also be noted that engine conversion packages in addition to giving users 110, 220 & 440-volts that could be used in a power emergency to power buildings, and such like; It also supplies air-compressors that can be used by trade and craft people, and home owners, for things like nail guns, spray guns, sandblasting, and power washing, and such like.

### Drawing Reference Numerals and Nomenclature

40 24-Volt Meter (VM)

41 24-Volt Hour Meter (HM)

42 24-Volt-175-Amp Emergency Switch (ES)

44 24-Volt-20-Amps Instrument Fuse (F)

45 24-Volt-50-Amp Motor Circuit Breaker (F)

46 Module Base Or Housing

48 12-Volt Deep Cycle Battery (B1)

48A 12-Volt Deep Cycle Battery (B2)

50 24-Volt-1-HP Motor (M1)

50A 24-Volt-1-HP Motor (M2)

52 12-Volt-10-Amp Fuse (F)

54 12-Volt-78-Amp Alternator (A1)

54A 12-Volt-78-Amp Alternator (A2)

56 2) ⅝″-v, Alternator Pulley Belts

57 ⅝″-v, Generator Pulley Belt

58 ⅝″-double-v, Alternator Pulley (P)

59 ⅝″-v, Generator Pulley

60 Motor On Light

64 Motor On/Off Switch, 24-Volt-60-Amps

66 12-Volt Alternator Exciter Switch

68 12-Volt Alternator Exciter Light

69 24-Volt-50-Amp Motor Circuit Breaker (F)

72 Computerized Control Device (CP)

73 Speaker

74 Alternator Supports With Adjustment

76 Horse Power Load Shaft

76A Drive Shaft Assembly

78 Chain & Sprocket Assembly (CS1) 7-1 Load Ratio

78A Chain & Sprocket Assembly (CS2) 7-1 Load Ratio

80 Bridge Supports For Pillow Blocks

82 Pillow Blocks

84 24-Volt Main Hot Wire

85 24-Volt Negative Wire

86 12-Volt Alternator Exciter Switch

88 12-Volt-10-Amp Fuse (F)

90 12-Volt Alternator Exciter Light

92 24-Volt-60-Amp Motor On/Off Switch

94 24-Volt Motor On Light

96 12-volt positive wire to (A1)

97 12-Volt Negative Wire to (A1)

98 12-Volt Negative Wire to (A2)

99 12-Volt Positive Wire to (A2)

100 AC-Generator-110/220-volts

101 110-volt wires to 12-volt-DC Battery Charger

102 Tire well in trunk of car

104 24-volt Positive Signal From Computer

105 12-volt Deep Cycle Battery

106 12-volt Deep Cycle Battery

108 24-volt Positive Wire from Back-up Battery

109 Spare Tire Hold-down Bolt

110 110-volt-AC to 12-volt-DC Battery Charger

111 110-volt-AC to 12-volt-DC Battery Charger

112 24-volt/175-amp contact on Jumper Relay

113 Conventional Air-pump

114 Remote Communicator/Controller

116 2) 110-volt-AC Circuit Breaker Panels

117 Sound Proof Cover

118 Conventional Shut-off Valve

120 440-volt-AC Circuit Breaker Panel

122 Monitor

123 Adjustable Legs

124 Temperature and Pressure Relief

126 Thermostat Control

128 Conventional Pressure Gauge

129 Air-hose Snap-On Connection

130 Conventional Pressure Control

131 Conventional Pressure Control

132 Drive-pump and Pulley assembly

134 440-volt Pump Motor

135 Holding Tank

136 Holding Tank

138 Existing Bed of Automobile

139 Non-conductive Spacer

140 Positive Terminal

142 2) Terminal Tumbler Insulator Seives

144 110-volt Wires to 12-volt-DC Battery Charger

150 24-volt Negative Wire from Back-up Battery

152 220-volt-AC Circuit Breaker Panel

154 12-volt Signal Wire to Hour Meter

156 Non-conductive Quick Change Battery Consul

157 Battery Compartment

158 Terminal Tumbler Locking Handle

160 Battery Compartment with Handles

162 Terminal Tumblers

164 Terminal Tumbler Receptacle

166 Terminal Securing Devices

168 Negative Terminal

170 220-volt-AC Power Cord to Air-distributor Heating Coil

301 Non-conductive Thermal Spacers

333 12 or 24-volt Electric Magnet

334 220-volt Power Cord to Motor Control with Twist-lock Plug to Electrical Power System

335 220-volt Power Cord to Tank Heating Coil with Twist-lock Plug to Electrical Power System

336 Permanent Magnet

337 Tension Spring

338 Holes for securing Module

340 Existing Spark Plug Wires

342 Air Pressure Regulator

344 Lower Compartment for Conversion Kit

346 Hatch-back Top Compartment for Luggage

348 Power Lead from Air-distributor Heating Coil with Twist-lock Plug to Electrical System

352 Existing Engine

353 Existing Carburetor/Air-cleaner Case

354 Existing Starter Wire

356 Existing Distributor

358 Existing High Energy Coil

360 Lift Tail Gate

362 Intake to Air-distributor

364 Rubber Grommet

367 Jacketed Compressed Thermal Insulation

368 Heating Coil Thermostat Control

369 Threaded Boss for grounding to Engine

370 Temperature and Pressure Relief

372 Air Outlet

376 Connection for Spark Plug Wires

377 EZ12 Air-admittance Valve(12-volts)

378 Temperature & Pressure Taps

379 EZ24 Air-admittance Valve(24-volts)

380 Instrument Temperature & Pressure Gauge

382 Bracket Mounting Plate

384 Horizontal Drain Plug

388 Canister Cover and Gasket

389 110-volt-AC Heating Coil

390 Cover Hold-down Bolts

392 Regulator Adjusting Screw

394 Air-distributor Canister

396 Accelerator Pedal

397 Mounting Hardware ½ Threaded Rod

398 Accelerator Linkage Connection

400 440-volt Power Cord to Motor Control with twist-lock Plug to Electrical Power Supply System

402 220-volt Power Cord to Heating Coil with Twist-lock Plug to Electrical Power Supply System

404 Air Distributor Support Bracket

406 Carburetor Canister Cover

408 Carburetor Type Air-distributor Assembly

410 Carburetor Air Intake

412 Utility Cabinet with Upper and Lower Compartments

414 Utility Cabinet with Upper and Lower Compartments

415 Spiral Internal flutes to cause air to spin in counter-clockwise rotation

416 Engine Housing

418 Crank-shaft

419 Lift-rod and Plunger

420 Air-chamber

421 Air-piston

422 Compression and Vent Valve

423 Directional Arrows for Water Jacket

424 Air-vent Manifold

426 Rubber Shock-absorbers

428 Fluid Chamber

430 Two 12-volt Batteries connected in series

432 Main 24-volt Wire

434 24-volt Main Distributor Wire

436 Starter Wire

438 Conventional Distributor

440 Alternator and Charge Wire

442 Distributor Wires to Air-admittance Valve

444 24-volt Fuse box

448 Air Re-cycle Funnel to Pump Intake

458 Tank Legs

460 Drain Hose

462 Air Intake Hose

464 Rubber Spacer

465 Collar Nut to fit Air-admittance Valve

468 Access Cover with High Temp. Gasket

470 Air-filter

472 Sound-proof Cover

474 Conventional Two Stage Air-pump

477 Balloon Plug

478 Tank Heating Coil

480 Jacketed Thermal Insulation

481 Nut Collar to fit 13/16″ Spark Plug Socket

482 Tank Heating Coil

483 Pneumatic Injector Nozzle Orifice

484 ‘O’ Ring Rubber Seal

485 Nut Collar to fit ⅝″ Spark Plug Socket

486 Threaded to match Engine Block for original Spark Plugs

487 Spiral Internal Flutes to cause air to spin in a counter-clockwise rotation

488 Snap-On type Hose Connector

490 Insulate Thermal Air-hose

777 Pneumatic Injector Nozzle

1. What I claim is a means to convert the conventional internal combustion gasoline automobile engine to a fuel-free and pollution-free continuous operating automobile engine with unlimited range of travel incorporating a modification of perpetual motion fan module clamed in Co-pending application (U.S. Pat. No. 10/811,382) modified to include and comprising:
(a) providing AC generator capable of delivering 110/220-volts to a load and secured to device and
(b) providing 220/440-volt AC transformer package to deliver 440-volts to a load and secured to device and
(c) providing back-up batteries and chargers capable to operate system if needed and secured to device and
(d) installing computerize system to monitor and control said device and supplies AC power for multiple purpose use and
(e) delivering it to light weight low noise high pressure air-manufacturing device designed as new use specifically for automobile industry capable of delivering necessary heated CFM of pneumatic energy and
(f) sending it to high temperature and pressure pneumatic energy distribution system designed as new use specifically for automobile industry capable to cause pneumassis reaction and
(g) delivering it through Pneumatic injector plugs designed as new use specifically for automobile industry which replaces engine spark plugs and gasoline with heated air
whereby causing movement of internal engine parts enough to cause said automobile to self-propel from one place to another.

2. What I claim is a means to replace the conventional diesel automobile engine with a fuel free and pollution free continuous operating automobile engine with unlimited range of travel comprising:
(a) providing fluid chambers with hydraulic fluid and
(b) providing plungers with lift-rods connected to
(c) crank-shaft and
(d) providing air-chambers containing air-pistons which forces fluid downwards and is activated by heated pneumatic energy
whereby as said pneumatic energy forces said air-piston downwards said hydraulic fluid forces said plunger and lift-rods upwards causing said crank-shaft to rotate
whereby said repeated action causes said automobile to self-propel from one place to another as said engine is inter-connected and enclosed in appropriate casing and installed in appropriate automobile.

3. What I claim is a means to quickly replace conventional automobile or marine type batteries without removing bolts nuts washers or clamps comprising:
(a) providing non-conductive casing with file cabinet like battery compartment or compartments which allows batteries to be installed in said compartments with positive and negative poles connected and
(c) providing terminal tumblers with interlocking devices which exits casing to rear and
(d) providing front terminal tumbler locking handles on said battery compartments also
(e) providing front battery compartment handle to move said battery compartment in and out and
(f) providing insulated outer terminal plate to power devices
whereby operator can change battery by rotating said tumbler locking handles and removing said battery compartment with battery in place and replace with new battery compartment with new battery already in place and locking said tumbler handles
whereby allowing device to be put back in service and ready for use.
